(19) United States
(12) Patent Application Publication
(10) Pub. No.: US 2026/0018041 A1
(43) Pub. Date: Jan. 15, 2026

(54) MONITORING SYSTEM CONTEXTUAL AGENT

(71) Applicant: Alarm.com Incorporated, Tysons, VA (US)

(72) Inventors: Benjamin Asher Berg, Washington, DC (US); Aren Max Vogel, Washington, DC (US); Michael Anthony Lawrence, Bristow, VA (US); Allison Beach, Leesburg, VA (US); Abraham Joseph Kinney, Vienna, VA (US); Donald Madden, Columbia, MD (US)

(21) Appl. No.: 19/256,525

(22) Filed: Jul. 1, 2025

Related U.S. Application Data
(60) Provisional application No. 63/670,167, filed on Jul. 12, 2024.
(60) Provisional application No. 63/760,838, filed on Feb. 20, 2025.

(51) Int. Cl. G08B 21/24; G06F 16/383; G06F 16/387

(52) U.S. Cl. CPC G08B 21/24; G06F 16/383; G06F 16/387

(57) ABSTRACT

Methods, systems, and apparatus, including computer programs encoded on computer storage media, for determining monitoring system actions using contextual information. One of the methods includes providing, to an artificial intelligence model and for an event at a property, contextual information that includes a) first data representing sensor data for the event, b) a role of a person for whom notification instructions are sent, c) an event type for the event, and d) activity data that indicates an activity in which the person is likely involved; in response to providing the contextual information, receiving, from the artificial intelligence model, output that indicates an action for the event; and sending, to a device, instructions to cause the device to perform the action.

### CROSS-REFERENCE TO RELATED APPLICATION

This application claims the benefit of U.S. Provisional Application No. 63/670,167, filed Jul. 12, 2024 and U.S. Provisional Application No. 63/760,838, filed Feb. 20, 2025, the contents of which are incorporated by reference herein.

### BACKGROUND

Monitoring systems can include settings and features for property management. A monitoring system can present notifications about the property through a user interface.

### SUMMARY

In general, one innovative aspect of the subject matter described in this specification can be embodied in methods that include the actions of providing, to an artificial intelligence model and for an event at a property, contextual information that includes a) first data representing sensor data for the event, b) a role of a person for whom notification instructions are sent, c) an event type for the event, and d) activity data that indicates an activity in which the person is likely involved; in response to providing the contextual information, receiving, from the artificial intelligence model, output that indicates an action for the event; and sending, to a device, instructions to cause the device to perform the action.

Other implementations of this aspect include corresponding computer systems, apparatus, computer program products, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination.

In some implementations, the method can include: determining the person for whom notification instructions are sent; and accessing historical notification data for the person. Providing the contextual data can include providing, to the artificial intelligence model and for the event at the property, the contextual information that includes a) the first data representing the sensor data for the event, b) the role of the person for whom notification instructions are sent, c) the event type for the event, d) the activity data that indicates an activity in which the person is likely involved, and e) the historical notification data for the person.

In some implementations, the method can include selecting, from a plurality of people and using the first data representing the sensor data for the event or the event type for the event, the person.

In some implementations, the method can include determining the person for whom notification instructions are sent; and accessing recent historical notification data that is i) for the person, and ii) that indicates notifications presented, during a time period that satisfies a time period threshold for the event, by one or more of devices for an account associated with the person, or presented by devices for the person. Providing the contextual data comprises providing, to the artificial intelligence model and for the event at the property, the contextual information that includes a) the first data representing the sensor data for the event, b) the role of the person for whom notification instructions are sent, c) the event type for the event, d) the activity data that indicates an activity in which the person is likely involved, and e) the recent historical notification data for the person.

In some implementations, the method can include receiving a request prior to providing the contextual information to the artificial intelligence model. Providing the contextual information can include providing, to the artificial intelligence model, the contextual information that includes second data for the request.

In some implementations, receiving the output can include receiving the output that indicates a notification regarding the event for presentation.

In some implementations, the method can include determining, using at least a portion of the output, a presentation type for the notification; and generating the notification using the presentation type.

In some implementations, the presentation type can include at least one of a visual notification or an audible notification.

In some implementations, the method can include selecting, from two or more notification types and using at least a portion of the output, a notification type; and generating the notification using the notification type.

In some implementations, the notification type can include a response that satisfies a response criterion, a suggestion that does not satisfy the response criterion and satisfies a suggestion criterion, or a request for additional information.

In some implementations, the first data representing the sensor data for the event can be the sensor data.

In some implementations, the method can include determining that values for one or more predetermined attributes of the sensor data are not stored in memory. Providing the contextual information to the artificial intelligence model can include providing the contextual information for the event at the property that includes the sensor data in response to determining that values for the one or more predetermined attributes of the sensor data are not stored in memory.

In some implementations, the first data representing the sensor data for the event can be a vector that represents values for one or more predetermined attributes of the sensor data.

In some implementations, the vector can represent values for the one or more predetermined attributes that each satisfy a relevance criteria for the event.

In some implementations, the vector can represent values for the one or more predetermined attributes that each satisfy a relevance criteria for the event type.

In some implementations, the method can include generating, using sensor data from one or more devices for the property, a textual representation of at least a portion of the event; and storing, as at least some of the first data representing the sensor data for the event, the textual representation of at least the portion of the event.

In some implementations, the textual representation of at least the portion of the event can be a vector.

In some implementations, the contextual information can include a location for the event.

In some implementations, the contextual information can include one or more of historical data for the property, second data that indicates whether the event is expected, an event trigger type, or a state of a monitoring system at the property.

In some implementations, the role for the person can include at least one of an emergency responder, a visitor at the property, a manager for the property, or a security person for the property.

In some implementations, the method can include determining an event type of the event at the property; and determining whether the event type satisfies an event type criterion that identifies an event for which a default action should always be performed. Providing the contextual information to the artificial intelligence model can be responsive to determining that the event type does not satisfy the event type criterion and that the default action should not always be performed for the event.

This specification uses the term “configured to” in connection with systems, apparatus, and computer program components. That a system of one or more computers is configured to perform particular operations or actions means that the system has installed on it software, firmware, hardware, or a combination of them that in operation cause the system to perform those operations or actions. That one or more computer programs is configured to perform particular operations or actions means that the one or more programs include instructions that, when executed by data processing apparatus, cause the apparatus to perform those operations or actions. That special-purpose logic circuitry is configured to perform particular operations or actions means that the circuitry has electronic logic that performs those operations or actions.

The subject matter described in this specification can be implemented in various implementations and may result in one or more of the following advantages. In some implementations, the systems and methods described in this specification can reduce computational resource usage, e.g., by predicting a presentation type for a notification instead of requiring user input indicating that a different presentation type is necessary. In some implementations, the systems and methods can more accurately handle ambiguous requests, e.g., using contextual information for the requests; can provide more accurate output, e.g., by using predetermined attributes of sensor data that describe an event; or a combination of both, compared to other systems. In some implementations, the systems and methods described in this specification can provide more flexibility for determining monitoring system actions, e.g., by using an artificial intelligence model that generates output, e.g., responsive data. The artificial intelligence model can be a large language model (“LLM”), e.g., a multi-modal LLM, or any other appropriate type of model, e.g., generative artificial intelligence model. In some implementations, the systems and methods described in this specification can more accurately determine a device that should present a notification, e.g., using output from the artificial intelligence model, contextual information, data from a request, or a combination of two or more of these. In some implementations, the systems and methods described in this specification can reduce latency of actions performed, e.g., by using values for the one or more predetermined attributes of sensor data that are stored in memory.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 depicts an example environment in which a system uses contextual data from a property.

FIG. 2 is a flow diagram of a process for using contextual information to determine an action.

FIG. 3 is a diagram illustrating an example of a property monitoring system.

Like reference numbers and designations in the various drawings indicate like elements.

### DETAILED DESCRIPTION

Conversational agents can provide users with information about a property, such as an event at the property. However, the information might not be presented in the most efficient manner given an activity of the user, might not include the most relevant information, or a combination of both.

A system can use contextual information, for the user, the property, or both, to generate a notification for the user, perform another action, or both. The notification can be part of a session with a conversational agent. By using the contextual information, the system can generate more accurate responses, determine more accurate response types, or both. For instance, when the system detects an event at the property, the system can determine an activity in which a property owner is involved. The activity can be jogging, driving, or reading a book. The system can determine a presentation type given the activity type, the alert type, or data for presentation in the notification. For example, the system can generate an audible notification when the person is jogging or driving and generate a visual notification when the person is reading a book or the notification should include an image depicting at least a portion of the event.

In some implementations, the system can determine whether to present a notification, what type of information should be included in the notification, e.g., a notification type, or both. The system can use the contextual information when making one or both of these determinations. For instance, the system can determine that since the property owner is driving, the system should provide a device for the property owner with less (or more) information than the device would normally be provided if the property owner were involved in another activity. A device for the property can be a device at the property or otherwise associated with the property, e.g., having a monitoring system account for the monitoring system for the property.

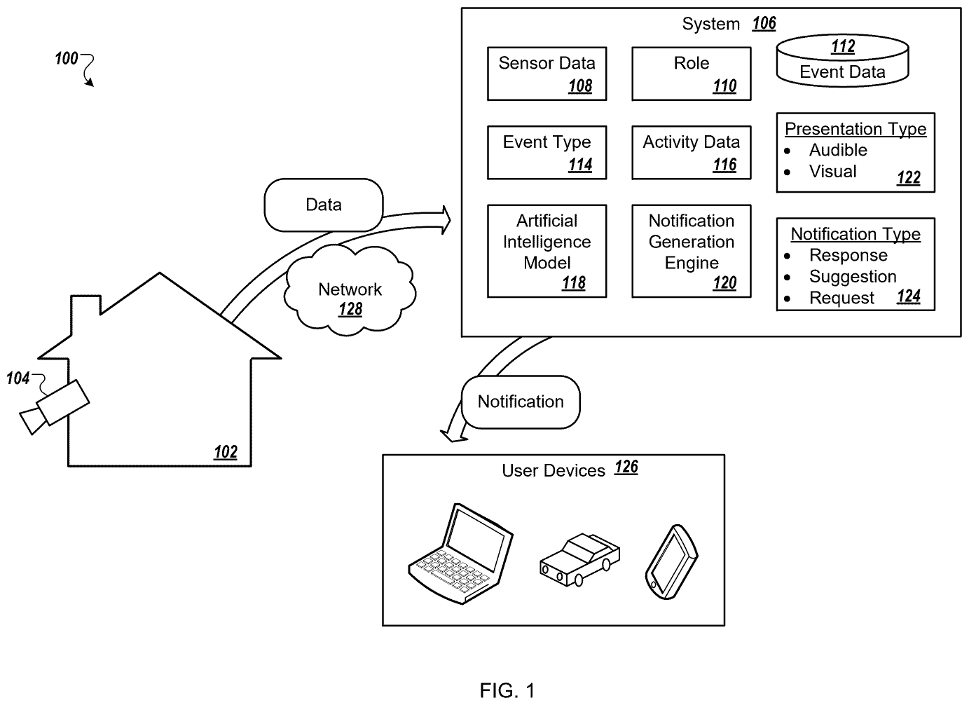

FIG. 1 depicts an example environment 100 in which a system 106 uses contextual data from a property 102. The system 106 can process the contextual data to generate more accurate notifications compared to other systems without the contextual data. As a result, a monitoring system for the property, e.g., that implements the system 106 or otherwise communicates with the system 106, can provide more accurate notifications, more flexible notifications, or a combination of both, to a user device 126.

The property 102 includes one or more devices 104, e.g., sensors. The devices 104 can be any appropriate type of device, such as a camera, a microphone, a speaker, or a smart appliance, to name a few examples.

The system 106 receives data from the one or more devices 104. The data can be any appropriate type of data generated by any of the one or more devices 104. For instance, the system 106 receives sensor data 108 from the one or more devices 104. The sensor data can include video images, video streams, sensor metadata, or a combination of these. Sensor metadata can include sensor malfunction status data. The sensor data 108 can be a type of contextual information for the system 106.

The contextual information can include multiple different data types, such as the sensor data 108, role data 110, event data 112, multiple event types 114, activity data 116, multiple event trigger types, a state of the monitoring system at the property 102, data for a person associated with the property 102, monitoring response data, user input, conversational data from one or more participants, or a combination of two or more of these. The state of the monitoring system can include armed or disarmed. The state of the monitoring system can include home, away, or another appropriate state.

The role data 110 can indicate a role of a person to whom a notification for the property 102 might be sent. For instance, a person's role can include owner, occupant, visitor, administrator, parent, child, grandparent, house sitter, manager, emergency responder, security person, another appropriate role, or a combination of two or more of these.

The data for a person, e.g., person data, can be any type of data about a person's current status, behavioral patterns, or a combination of both. For instance, the person data can indicate if the person is currently using a mobile application, the speed at which the person is moving, or a combination of both. In some examples, the person data can indicate an activity in which the person is involved, e.g., driving or running. The person data can indicate an identity of the person, e.g., from previously stored data or input identifying the person. The person data can indicate what color, design, or both, uniforms are expected to be worn at the property 102. The system 106 can receive some of the person data in response to a request for the person data, e.g., the specific person data or person data in general.

The monitoring response data can indicate different types of data associated with the response to a monitoring event. For instance, the monitoring response data can indicate that the system 106, e.g., a monitoring system, issued a request for an operator to coordinate with a service to dispatch law enforcement. In some examples, the monitoring response data can represent information about an environment around a first responder's location, e.g., of a responding law enforcement agency or other appropriate data. For example, the monitoring response data can include data from other sources that relate to a response to an event at the property 102, such as a response from a health care professional, a response by a neighbor, or a combination of both.

The user input, conversational data, or both, can include data the system 106 collected previously from devices operated by various users of the system 106. These data types can include any appropriate type of user input or conversational data. In some examples, the conversational data can include data from a conversational agent executing on a user device, a prompt-response session for the user device, or a combination of both. For instance, a user device can provide, to the system, data indicating that the user is not on the premises and anyone who is observed is trespassing. This type of data can be either user input, conversational data, or a combination of both, depending on how the system 106 receives the data, e.g., whether the input is part of a conversation with the system 106. In some examples, this data can indicate a user's intent in interacting with the system 106, e.g., in response to a request, from the system 106, to know the user's intent in interacting with the system 106. In some instances, the conversational data can include information about the preferred style of conversation of the user. The conversational data can include information about the tone of the user's voice, their typing or keystroke patterns, or a combination of these.

Data for a session can include any appropriate type of data. Some examples of these types of data can include data determined to use during the session, actions determined to take, messages received from a person, messages provided to the person, or a combination of these.

The event data 112 can be any appropriate type of data about events at the property 102. For instance, the event data 112 can include historical data for the property 102, e.g., indicating events detected, historical sensor data, previously provided notifications, or a combination of two or more of these. The event data 112 can include data that indicates whether an event is expected to happen, a time period during which an event is expected to happen, a location at which the event occurred, e.g., within the property 102, or a combination of both. For instance, the event data 112 can indicate that the property owner leaves around 7:30 am each weekday, except every other Wednesday.

The event types 114 can indicate multiple different types of events that might occur, have occurred, or a combination of both, at the property 102. In some examples, the event types 114 can indicate types of events that are identified as events of interest, e.g., by an administrator for the property 102. For instance, the event types 114 can include suspicious person, detected animal, package delivery, resident arriving or leaving the property 102, or guard on patrol at or near the property 102, to name a few examples.

The activity data 116 can indicate a likely activity in which a person is likely involved. For example, the system 106 can maintain, for the property 102, a list of accounts or people for whom notifications can be sent, e.g., to a corresponding user device 126, upon detection of a corresponding event. The activity data 116 can indicate, for at least some of the accounts or people, corresponding activities in which the corresponding person is likely involved. For instance, a system can determine, e.g., using sensor data or data from the user devices 126, activities in which the people are likely involved. The activities can include driving, sleeping, reading, jogging or participation in another type of physical activity, working, cooking, playing, gardening, or watching television, to name a few examples.

The event types can indicate a way in which a message to the system 106 was triggered. For instance, the monitoring system for the property can detect an event represented by at least some of the sensor data 108, receipt of input indicating an event, or a combination of both. The receipt of input indicating the event can include input received by an application, e.g., executing on one of the user devices 126, input received by a physical control panel at the property 102, or a combination of both.

The system 106 provides the contextual data to an artificial intelligence model 118, e.g., in response to receipt of the event trigger. For instance, the conversational system can use the event type 114 to determine a subset of the contextual data to provide as input to the artificial intelligence model 118. This can occur because the artificial intelligence model 118 can analyze different types of events differently, e.g., different types of contextual information might be more or less relevant for the different event types. For example, historical data might be more relevant to an event that occurs during a guard's patrol, e.g., to generate a more contextually relevant notification for a guard's device, while that historical data might be less relevant to a different event such as when a person falls.

In some examples, the system 106 can determine the types of contextual information using a state of the property 102, a state of the monitoring system at the property, or a combination of both. For instance, the system 106 might provide more contextual information when the monitoring system's state is armed/away than if the monitoring system had a different state, e.g., unarmed or home or both. In some examples, the system 106 might provide all contextual information to the artificial intelligence model 118.

The system 106 can receive output from the artificial intelligence model 118. The output indicates a notification regarding the event and can indicate one or more recipient accounts or devices, a presentation type 122, a notification type 124, an automated action, a state of change for the system 106, or a combination of these. The notification can have any appropriate presentation type 122, e.g., visual, audible, or a combination of both. In some examples, the presentation type 122 can indicate that nothing should be presented to a target, e.g., there should not be a notification. The output can indicate the delivery of a media message composed of still images, a video clip, a three-dimensional (“3D”) rendering depicting the event, other visual media, or a combination of these. A still image can include a thumbnail of other content, e.g., a larger image, content from a video client, or other visual media. The message can be auditory such as a voice recording, a sound effect, or both. The output can indicate the delivery of a continuous stream of data. For example, the output may be composed of a continuous video stream, a continuous audio stream, a continuous stream of event data, e.g., other event data than an audio or video stream, or a combination of these. A stream of event data can include analytics about detected events, e.g., a stream of data that indicates when events were detected, the types of events detected, or a combination of both.

The notification can have any appropriate notification type 124. A notification type can represent how the notification responds to the event trigger. For instance, the notification type can be “response”, “suggestion”, “request”, “answer unavailable”, or “no action”. A response notification type can be output that satisfies a response criterion. The response criterion can require that the output has a likelihood that satisfies a response threshold of being responsive to the event trigger, e.g., a request.

A suggestion type can be output that does not satisfy the response criterion but satisfies a suggestion criterion. The suggestion criterion can be less restrictive than the response criterion. For example, when both criteria are percentages, the response criterion, e.g., the response threshold, can be a higher percentage than the suggestion criterion, e.g., a suggestion threshold. The suggestion criterion can require that the output has a likelihood that satisfies a suggestion threshold, e.g., while not satisfying the response threshold. For instance, when the artificial intelligence model 118 determines output that has a 55% likelihood of being responsive to the event trigger and the response threshold is 80% while the suggestion threshold is 50%, the system 106 can determine that the notification type is suggestion instead of response.

In some implementations, the system 106 can select a suggestion type. The system can select the suggestion type using a result of whether an importance score satisfies a threshold. The importance score can represent how interesting, unusual, or both, the data in the suggestion is. The importance score can be based on a person to whom the suggestion is intended to be presented. For instance, the system 106 can determine whether to include, in the notification, an importance descriptor for the event. Some examples can be the notification indicating that “everything is normal” or “you should listen to this”.

A request type for the output can indicate that the output is a request for additional information. For instance, if the artificial intelligence model 118 is uncertain about some of the input, e.g., contextual data or a specific request included in its input, the artificial intelligence model 118 can generate output that is a request for additional information. In these implementations, the artificial intelligence model 118 can response a response to the request and generate second output, e.g., which can have a different notification type.

In some examples, the system 106 can receive output that has a notification type of answer unavailable. This type of output can indicate that the artificial intelligence model 118 does not have data responsive to a request. This can occur when the artificial intelligence model 118 receives input that identifies a request, e.g., “is the person carrying a package”, and the artificial intelligence model 118 has insufficient data to answer the request, e.g., any pictures of the person are of their back and do not show the person's hands.

The system 106, e.g., a notification generation engine 120, can generate the notification for the output. For instance, the output might indicate data responsive to the event trigger but not include appropriate data for the actual notification. The system 106 can use the notification generation engine 120 to generate data that causes presentation of the notification, e.g., using one or both of the presentation type 122, or the notification type 124.

For example, the notification generation engine 120 can generate instructions for presentation of data from the output in a user interface on a user device 126. When the output indicates a recipient account for the notification, and the activity data 116 indicates a particular activity for that account, e.g., a person associated with that account, the notification generation engine 120 can customize the instructions for presentation of the user interface given the activity data, the account, the corresponding notification type, or a combination of these, given a presentation type of “visual.”

In some examples, the notification generation engine 120 can generate an encoding of speech for presentation, e.g., can include a text to speech conversion engine. In these examples, the notification generation engine 120 can use any appropriate type of data, e.g., as described elsewhere in this specification, to generate the encoding. For instance, the notification generation engine 120 can generate the encoding that indicates that a corresponding user device 126 will present an image for the event, e.g., “there is an alert about a suspicious person. Please look at your phone or computer for an image of the person.”

In some implementations, the output can indicate an automated action, e.g., for the monitoring system or another device at the property 102 to perform. Some examples of automated actions include presenting a message to a person at the event, e.g., to deter a suspicious person from staying at the property 102, to provide medical assistance to a person who fell, or another appropriate message. Some automated actions can include sending a drone to a person's location, presenting a visual or audible message, turning lights on or off, or locking or unlocking a door, to name a few examples.

In some implementations, the contextual data used as input for the artificial intelligence model 118 can include historical data for the property 102. The historical data can include prior output generated by the artificial intelligence model, prior session data, or a combination of both. For instance, the system 106 can maintain historical output data for the property 102 in a database, e.g., an encrypted database. Upon determining to generate another notification for the property 102, the system 106 can access at least a portion of the historical output data and use that historical output data as input to the artificial intelligence model 118.

In some implementations, the system 106 can generate at least some of the event data 112 prior to receiving a request, e.g., from a user device 126, prior to providing the contextual information as input to the artificial intelligence model 118, or a combination of both. The generated event data can indicate values for attributes of the sensor data 108, the activity data 116, other appropriate contextual information, or a combination of two or more of these. The attributes can be predetermined attributes, e.g., attributes identified as satisfying a relevancy criterion for events of interest. For instance, the attributes can be whether a person is carrying anything, what the person is carrying, the color clothing of the person, whether a detected entity is an animal, what type of animal, whether the entity is likely injured, or a combination of these. In some examples, the attributes can be attributes that satisfy a responsiveness criterion of being responsive to a request for information.

For example, the system 106, e.g., the artificial intelligence model 118 or another model that analyzes the sensor data 108, can generate the attributes as the system 106 receives the sensor data 108. While a guard is on patrol at the property 102, the attributes can indicate a likely location of the guard at the property 102, a location of another person at the property 102, what if anything the other person might be carrying, and other information about the other person.

The system 106 can store the attributes in any appropriate manner. For instance, the system 106 can store the attributes as metadata for the corresponding contextual information, store the attributes in a database, e.g., that maintains the corresponding contextual information or a separate database, or a combination of both.

In some examples, the system 106 can store the attributes as a vector. The vector can have locations that indicate attribute types, e.g., predetermined attribute types. The vector can have a location that indicates the corresponding contextual information. The various locations in the vector can include corresponding values for the corresponding attribute types.

The system 106 can generate the attributes by processing the contextual information, e.g., as the contextual information is received from the devices 104 at the property 102. For instance, when the contextual information is video data that includes a sequence of frames, the system 106 can provide each frame to an attribute model that generates values for the attributes. The attribute model can be any appropriate type of model, e.g., can be the same model as or a different model than the artificial intelligence model 118. In some examples, the attribute model can be a large language model (“LLM”), e.g., a multi-modal LLM.

By generating values for the attributes prior to receipt of a request, provision of the contextual information to the artificial intelligence model 118, or both, the system 106 can generate output more quickly, e.g., have a lower latency, than it would otherwise. For instance, by generating a vector that can be used as part of the contextual information provided as input to the artificial intelligence model 118, the system 106 can more quickly scan historical data to match the input to previously observed inputs, generate the output using the artificial intelligence model 118, or both. For example, each frame with an observation of a person may be encoded using a vision language model. The system 106 can store the encoded frame in memory. Subsequently, the system 106 might require a history of previous instances of “person wearing black hat” in the past day that are encoded in stored data. The system 106 could request such instances of stored data quickly by searching for an encoding of the text string instead of searching the video, e.g., images, itself.

In some examples, the values for the attributes can model, e.g., represent, activity at the property 102. For instance, the values can indicate attributes of events occurring at the property 102, such as the guard's patrol and the suspicious person.

In some implementations, the system 106 can determine whether to provide one or more additional notifications, or perform other appropriate additional actions. For instance, after the system 106 provides an initial notification to the user device 126, performs an initial action, or both, the system 106 can determine whether additional data received from the devices 104 is likely relevant to the event trigger. When the system 106 determines that the additional data is not likely relevant to the event trigger, the system 106 can continue processing data, e.g., generating the attribute values, receiving additional data, perform another appropriate action that is not a monitoring system action, or a combination of these. For instance, when the event trigger is detection of a person at the property and the additional data is activity data for a property owner going from a grocery store home or turning on a light, the system 106 can determine not to perform any additional actions for the event.

When the system 106 determines that the additional data is likely relevant to the event trigger, the system 106 can determine whether to provide another notification or perform another monitoring system action. For instance, as the system 106 receives the additional data, the system 106 can provide the additional data to the artificial intelligence model 118. The artificial intelligence model 118 can generate output that indicates whether an action should be performed, whether providing a notification or performing another type of action. For instance, when the person has walked a few feet from the location at which they were initially detected, and a drone or guard was already dispatched to the person's location, the artificial intelligence model 118 can generate output that indicates that no additional action need be performed. In these examples, the contextual information can indicate the actions already performed or otherwise triggered by the system 106 to enable the artificial intelligence model 118 to determine whether there are additional actions to perform.

The system 106 is an example of a system implemented as computer programs on one or more computers in one or more locations, in which the systems, components, and techniques described in this specification are implemented. The user devices 126 can include personal computers, mobile communication devices, and other devices that can send and receive data over a network 128. The network 128, such as a local area network (“LAN”), wide area network (“WAN”), the Internet, or a combination thereof, connects the devices 104, a monitoring system for the property 102, the system 106, and the user devices 126. In some examples, the system 106 can be part of, e.g., implemented on, the monitoring system at the property 102. In some examples, the attribute model can be located at the property 102, e.g., can be part of the property monitoring system, while the other components of the system 106 are separate from the monitoring system. The system 106, the monitoring system, or both, can use a single computer or multiple computers operating in conjunction with one another, including, for example, a set of remote computers deployed as a cloud computing service.

The system 106, the monitoring system, or both, can include several different functional components, including the artificial intelligence model 118, the notification generation engine 120, and the attribute model. The artificial intelligence model 118, the notification generation engine 120, the attribute model, or a combination of these, can include one or more data processing apparatuses, can be implemented in code, or a combination of both. For instance, each of the artificial intelligence model 118, the notification generation engine 120, and the attribute model can include one or more data processors and instructions that cause the one or more data processors to perform the operations discussed herein.

The system 106 and the monitoring system can be located at any appropriate physical location. For instance, the monitoring system can be located at the property, e.g., on one or more computers at the property, implemented in the cloud, or a combination of both. The system 106 can be implemented as part of the monitoring system or separately from the monitoring system. For example, the system 106 can be implemented at the property as part of the monitoring system, in the cloud—as part of the monitoring system or not, or some combination of both.

The various functional components of the system 106 can be installed on one or more computers as separate functional components or as different modules of a same functional component. For example, the components the system 106 can be implemented as computer programs installed on one or more computers in one or more locations that are coupled to each through a network. In cloud-based systems for example, these components can be implemented by individual computing nodes of a distributed computing system. In some examples, the artificial intelligence model 118, the attribute model, or both, can be implemented on one or more computers separate from the other components, e.g., from the notification generation engine 120.

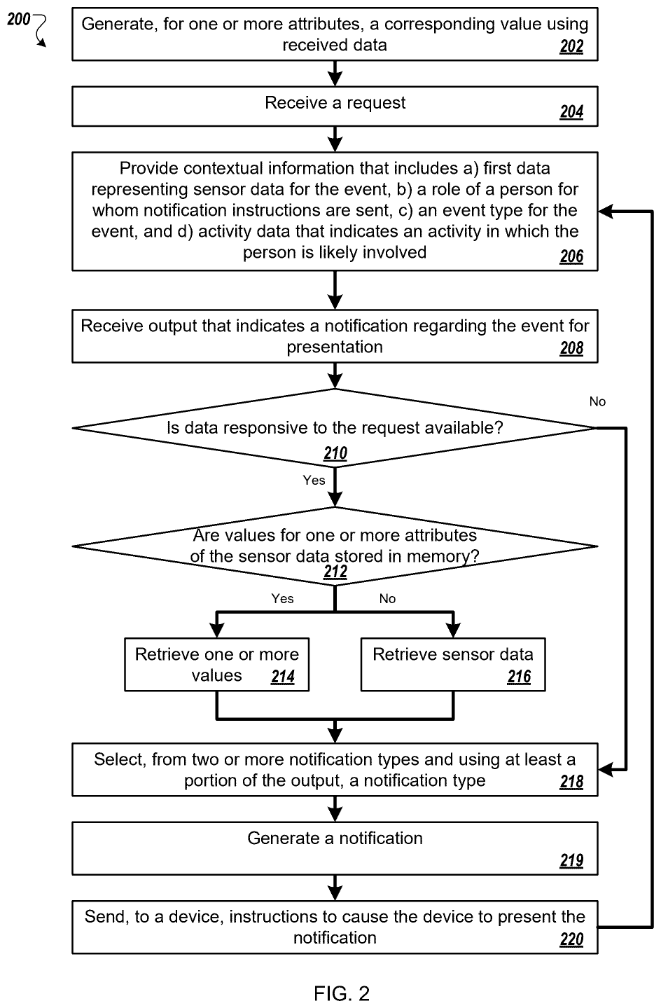

FIG. 2 is a flow diagram of a process 200 for using contextual information to determine an action. For example, the process 200 can be used by the system 106 from the environment 100.

A system generates, for one or more attributes, a corresponding value using received data (202). For instance, the system can analyze the sensor data or other appropriate contextual data to generate values for at least some of the attributes. The attributes can indicate data about one or more entities represented by the sensor data, e.g., when the one or more entities are involved in an event. In some examples, the attributes can indicate data about an entity represented across a stream of sensor data, e.g., an audio stream, a video stream, or a combination of both. For instance, an attribute can indicate a direction in which an entity is moving, which information might not be detectable given analysis of a single piece of sensor data, e.g., frame, alone.

The system receives a request (204). In some examples, the process 200 can include receiving a request, e.g., this can be an optional operation. The system can receive the request from any appropriate source, e.g., a monitoring system for the property, a user device, a contextual agent executing on the user device, or a combination of these. The request can be an alert trigger or another appropriate type of request for an action to perform. The action can be any appropriate type of action, such as presenting a notification, or sending a drone to inspect an area of a property.

The system provides contextual information that includes a) first data representing sensor data for an event, b) a role of a person for whom notification instructions are sent, c) an event type for the event, and d) activity data that indicates an activity in which the person is likely involved (206). In some examples, the system can provide a proper subset of this contextual information as input, e.g., only a and d, only a and b, only a, b, and c, only a, b, and d, or only a, c, and d. For instance, the system provides the contextual information to an artificial intelligence model. The contextual information can include any appropriate types of contextual information, e.g., described in this specification. The artificial intelligence model can be any appropriate type of model, e.g., a large language model.

The first data can be any appropriate type of data representing the sensor data. For instance, the first data can include at least part of the sensor data for the event, a vector that represents attributes of the sensor data or objects represented by the sensor data, other appropriate data for the sensor data, or a combination of two or more of these.

The values for the attributes can be any appropriate type of data. For instance, some of the attribute values can be textual data, e.g., a textual representation of at least a portion of the event, an object such as an entity involved in the event, or a combination of both. The textual representation can be a vector.

The activity data can be any appropriate data that is different data than the sensor data. For instance, although the sensor data is for an event that likely involves an object of interest, the person can be an occupant for a property at which the event occurred but likely would not be involved in the event itself. As a result, the two sets of data are separate data. In some instances, the person can be a person otherwise associated with the property but not an occupant of the property, e.g., the person might be away from the property when operation 206 is performed, might be a remote security person or first responder, or both. Some examples of objects of interest can include people, animals, and vehicles. Some examples of events, e.g., events of interest that optionally include an object of interest, can include another person walking up to a building at a property, a wild animal such as a deer entering the property, or a window at the property breaking.

The activity data and the sensor data can be captured by any appropriate one or more devices. For instance, the activity data can be captured by a first device, e.g., inside a building such as a home, and the sensor data can be captured by a second, different device, e.g., outside the building. In some instances, the activity data can be captured by a device during a first time period and the sensor data can be captured by the device during a second, different time period.

In some instances, the system, e.g., a model executing on the system, can compose a query using the contextual information. For instance, the system can determine a prompt for the artificial intelligence model using at least part of the contextual information.

The system receives output that indicates a notification regarding the event for presentation (208). For example, the system receives the output from the artificial intelligence model. The receipt can be responsive to providing the contextual information to the artificial intelligence model.

The output can be any appropriate type of output for the artificial intelligence model. For instance, the output can be a vector for which each value represents a corresponding type. The vector can include a presentation type value, a notification type value, one or more recipient accounts or devices or both, data for the event, other appropriate types of data, or any combination of two or more of these.

In some examples, the vector can be an array. In these examples, the one or more recipient accounts or devices can each receive different presentation types for the notification, different notifications, or a combination of both.

The system determines whether data responsive to the request is available (210). This operation can occur in instances in which the process 200 includes receiving a request, e.g., operation 204. In instances in which the process 200 does not include receiving a request, the process 200 might not include operation 210.

For instance, the system can use the presentation type, the data for the event, or a combination of both, to determine whether data responsive to the request is available. When the data for the event that was included in the output is empty, e.g., a null bit, the system can determine that data responsive to the request is unavailable. When the presentation type indicates that there should not be a notification, the system can determine that data responsive to the request is not available.

In some instances, data responsive to the event can have a type that is incompatible with the presentation type. In these instances, the system might determine that data responsive to the request is not available. This can occur when the system determines that data responsive to the event does not satisfy a presentation criterion for the presentation type. For instance, if the presentation type has an image type, e.g., for video or still images, but the data responsive to the event is in a text format that cannot be converted to an image type, the system can determine that data responsive to the event is not available.

The system determines whether values for one or more attributes of the sensor data are stored in memory (212). For example, in response to determining that data responsive to the request is available, the system determines whether attributes of the sensor data are stored in memory. The system can determine whether any attributes stored in memory are responsive. In some examples, when the output identifies the data for the event, the system can make this determination using at least a portion of the output. For instance, the output can indicate an identifier for where values for the attributes are stored in memory, e.g., in a database. In some examples, the output can include the values for the one or more attributes.

The system retrieves one or more values (214). For instance, when the output does not include the values themselves, the system can retrieve the one or more values from memory, e.g., from the database. In some examples, the system can retrieve the one or more values in response to determining that the values are stored in memory, e.g., and responsive to the request.

The system retrieves sensor data (216). For example, in response to determining that values are not stored in memory, that values stored in memory are not responsive, or both, the system can retrieve the sensor data. In some examples, the system can both retrieve one or more values and sensor data, e.g., depending on what data is or might be responsive to the request.

The system selects, from two or more notification types and using at least a portion of the output, a notification type (218). For example, the system can use data from the output to select the notification type. The system can use the data responsive to the request to select the notification type.

In some examples, selection of the notification type can include selection of a way to format data for the notification. For instance, the system can present a notification using the same presentation type but different presentation formats given different notification types. When the notification types include response, suggestion, or request, the system can format the notification differently for the different types. A response can indicate that data responsive to the request is available and identify such data. A suggestion can indicate that data potentially responsive to the request is available and identify such data. A request can be formatted to prompt a user for input.

The system generates a notification (219). The system can generate the notification using the notification type, the one or more values, the sensor data, or a combination of two or more of these. For instance, the system can use any appropriate process to generate a message that has the message type given the output from the artificial intelligence model.

In some examples, the system can select one or more other actions to perform. The other types of actions can be any appropriate type of action, such as triggering a lock at the property, sending a drone to a location at the property, or a combination of both.

The system can select an action to perform, when selecting a notification type or another type of action, in response to one or more triggers. For instance, the system can select the notification type that indicates that no data responsive to the request is available in response to determining, during operation 210, that no responsive data is available. The system can select the action, e.g., notification type, in response to performing either of operations 214 or 216.

In some implementations, as one of the actions, the system can store data about the output, the notifications, or both, to a database. For example, the system can create a record in the database that includes at least some of the contextual information, data that identifies the one or more actions, e.g., other than the database storage, and data about the notification. The system can then use this data record when generating future recommendations. The database can be a database specific to the property for which the notification is generated, e.g., have encryption specific to that property, be located at the property, or a combination of both. This can improve data security, privacy, or both, for the data.

The system sends, to a device, instructions to cause the device to present the notification (220). For example, the system sends the instructions to a user device. The instructions can include computer code or other appropriate types of instructions that cause presentation of the notification. In examples in which the system causes performance of an automated action, the system can send instructions to the device, e.g., any appropriate device, that cause the recipient device to perform the automated action, e.g., deployment of a drone or locking of a door.

The system can determine the device to which to provide the notification using output from the artificial intelligence model, the contextual information, or a combination of both. The device that presents the notification can be any appropriate device. For instance, the system can receive the request, e.g., as part of operation 204, from a first device for a property, e.g., operated by a first person. The system can provide the instructions, e.g., as part of operation 220, to a second different device, e.g., operated by a second different person.

In some implementations, the system can perform one or more operations of the process 200 multiple times. For instance, as the system receives additional data, e.g., sensor data, the system can determine whether the additional data indicates a change in the contextual information previously provided, e.g., to the artificial intelligence model. This can enable the system to dynamical determine, given changes in the contextual information, whether to change a notification type. For example, the system can proceed from operation 218, 219, or 220 to operation 202 or 206. In some examples, this can include the system performing an action, sending instructions to cause presentation of a notification, or both, given the received data and the contextual data, e.g., among others. The system can determine whether a person reacted to the notification or not. During this time period, the event that was the basis of the notification can continue to evolve. The system can then determine another action, notification, or both, to perform given the evolution of the event, changes in the activity data for the person, or both.

In some instances, this can include the system retrieving sensor data about a person depicted in a camera's field of view. The system can process the sensor data and cause presentation of an initial notification given the event. The system can determine to collect more information about the event. For example, the system can retrieve an image from a different camera. The system can process the sensor data and the image and determine an updated notification, action, or both. The system can cause presentation of a second, different notification, e.g., by performing one or more of operations 218 to 220.

The order of operations in the process 200 described above is illustrative only, and use of the contextual information to determine an action can be performed in different orders. For example, the system can generate one or more attribute values at least partially concurrently with, after, or a combination of both, receipt of the request. In some examples, the system can generate one or more attribute values at least partially concurrently with, after, or a combination of both, any of the operations in the process 200, e.g., operation 206, 208, 210, 212, 214, 216, 218, 220, or a combination of two or more of these.

In some implementations, the process 200 can include additional operations, fewer operations, or some of the operations can be divided into multiple operations. For example, the process 200 can include operations 206, 208, and 220. The process 200 can include operations 206, 208, and 220 and one or more of operations 210, 212, 214, or 216. Any of these implementations can optionally include operation 202 or 204.

In some implementations, the system can cause presentation of a notification to multiple people, or select a person or group of people from multiple people for presentation. For instance, the system can use at least a portion of the contextual data to determine an intended recipient for the notification. This can be part of operate 218 or otherwise performed before operation 219, e.g., when the notification generation might use data regarding the intended recipient.

In some instances, when a first notification is for a first person, the system can determine whether to cause presentation of a second notification for a second person. The system can make this determination given one or more notification criteria, e.g., when the system doesn't receive an expected command. A command can be caused by input from first person given presentation of the notification. When the system doesn't receive the expected command, the first person likely did not take a corresponding action that would cause that command.

In some examples, when the output does not identify the presentation type, the system can select the presentation type using some of the contextual data, e.g., the role for the recipient accounts or devices, an activity in which a corresponding person is likely involved, data responsive to the request, e.g., a type of the responsive data, a type of the event, historical data, or a combination of two or more of these.

In some implementations, the contextual data can include activity data indicating an activity in which the person is likely involved. The system can receive, from the artificial intelligence model, the output that indicates a time period during which to present the notification. For instance, the activity data can indicate that the person is carrying something, e.g., groceries into their home. The artificial intelligence model can analyze the activity data that indicates that the person is carrying something and determine that a notification for the event should be presented, but at a different time, e.g., after the person is no longer carrying the something, when the person is done with the activity that caused them to carrying the something, or another appropriate time. The system can use the time period data to determine when to send the instructions to cause the device to present the notification, that the generation of the instructions should identify the time period during which the notification should be presented or both. This can, for instance, allow the person to finish carrying all groceries into their home when the initial detection occurred during transfer of a first load of groceries.

In some implementations, the contextual data can include information about other notifications that have been presented within a threshold time period of the event. This can include recent historical notification data that indicates notifications presented by devices for an account associated with the person, e.g., the person's account, presented by devices for the person, or a combination of both. A device for the person can be a device operated by the person or a device within a threshold physical distance from the person. The system can provide the contextual data that includes the recent historical notification data to the artificial intelligence model. The artificial intelligence model can generate a recommendation on whether, when, or both, to present a notification using the recent historical notification data. To enable this functionality, the artificial intelligence model can be trained on recent historical notification data to enable the artificial intelligence model to determine whether, when, or both, a notification can be presented. The when to present a notification can include the artificial intelligence model generating output that indicates a time period for presentation of the notification, e.g., similar to the time period described above.

In some instances, the system can provide the artificial intelligence model with historical data, e.g., for the person, as input. This historical data can be part of the contextual data or separate data. The historical data can indicate historical notification interactions for the person. For instance, the historical data can indicate types of notifications for the person, how the person responded to at least some notifications, or both. The system, when providing notifications to the person, can capture sensor data that indicates the person's reaction to the notification. The system can store, in a database, data representing the interaction; data that indicates the notification or notification type; data that indicates the context in which the notification was presented; data that indicates a presentation type for the notification; or any combination of these, e.g., upon receipt of appropriate permissions from a device operated by the person as indicated below. The artificial intelligence model can be trained using historical data. During runtime, the system can provide the artificial intelligence model with at least some of the historical data to cause the artificial intelligence model to use the historical data when generating the output. This can cause the artificial intelligence model to generate the output that indicates a notification that is specific to the person, e.g., personalized for the person, that is a different type of notification, a different notification, or both, compared to a notification that the artificial intelligence model would have otherwise selected, or any combination of these.

In some implementations, this can cause the artificial intelligence model to determine if differences between a current notification and a prior notification, e.g., a notification presented within a threshold time period of a present time, satisfies a notification criterion. If so, the system can receive output from the artificial intelligence model indicating that the current notification should be presented, e.g., the current notification is sufficiently different from the prior notification. If not, the system can receive output from the artificial intelligence model indicating that presentation of data for the current notification should be skipped.

In some examples, the system can use a difference between a current notification and a prior notification, e.g., presented within a threshold time period of a present time, to determine when to present the notification. For example, the system can determine whether the differences between the current notification and the prior notification satisfy a priority criterion. If so, the system can determine that the current notification should be presented sooner than if the differences do not satisfy the priority criterion. For instance, the differences can indicate how urgently the current notification should be delivered.

As the system presents information related to the event, e.g., during a communication session with a device for the person, the system can continue to capture additional contextual data. This additional contextual data can indicate how the person is likely reacting to the communication session. For instance, the additional contextual data can indicate that the person might be stressed and now is a suboptimal time to continue the communication session about the event. To enable this functionality, the system can provide, during the communication session, the additional contextual data to the artificial intelligence model, optionally with the historical data.

The system can provide the historical data to the artificial intelligence model once for the communication session, or each time an additional response is necessary for part of the communication session, e.g., depending on settings or other appropriate types of permissions. In response to providing the additional contextual data, the system can receive, from the artificial intelligence model, second output that indicates a response for the system to perform during the communication session. The second output can indicate change in a notification type, a change in a presentation type, or both. The second output can indicate that the system should likely stop the communication session. This can reduce computational resource usage, e.g., by ending the communication session earlier or using a more efficient notification type or presentation type. The system can use the second output to determine how to continue the communication session, if at all.

For situations in which the systems discussed here collect personal information about people, or may make use of personal information, the people may be provided with an opportunity to control whether programs or features collect personal information (e.g., information about a person's activities, a person's preferences, or a person's current location), or to control whether and/or how the system operates. In addition, certain data may be anonymized in one or more ways before it is stored or used, so that personally identifiable information is removed. For example, a person's identity may be anonymized so that no personally identifiable information can be determined for the person, or a person's geographic location may be generalized where location information is obtained (such as to a city, ZIP code, or state level), so that a particular location of a person cannot be determined. Thus, the person may have control over how information is collected about him or her and used.

In this specification, the term “database” is used broadly to refer to any collection of data: the data does not need to be structured in any particular way, or structured at all, and it can be stored on storage devices in one or more locations. A database can be implemented on any appropriate type of memory.

In this specification the term “engine” is used broadly to refer to a software-based system, subsystem, or process that is programmed to perform one or more specific functions. Generally, an engine will be implemented as one or more software modules or components, installed on one or more computers in one or more locations. In some instances, one or more computers will be dedicated to a particular engine. In some instances, multiple engines can be installed and running on the same computer or computers.

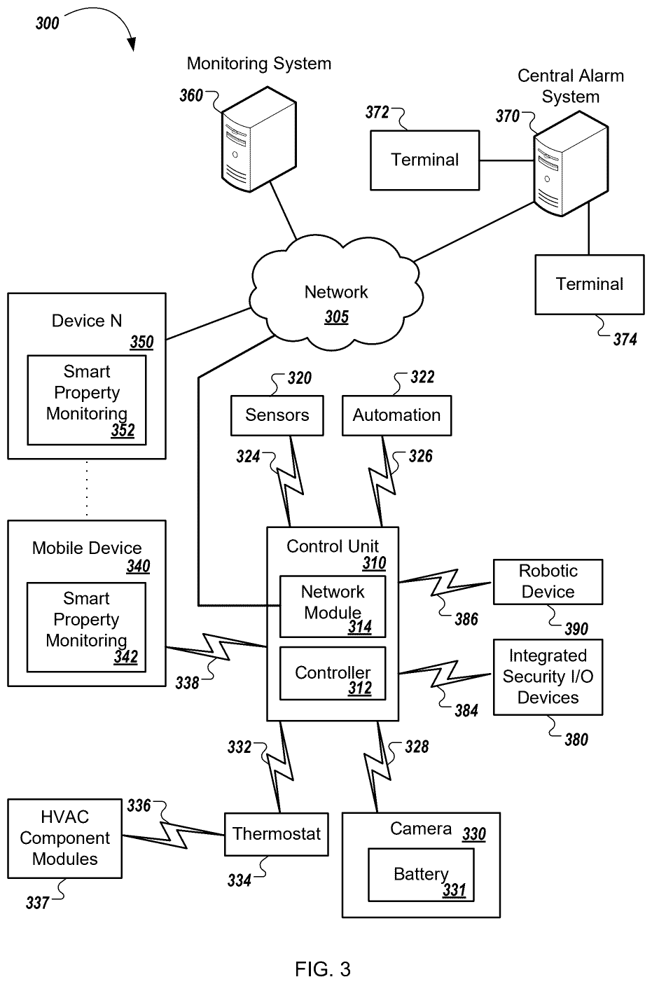

FIG. 3 is a diagram illustrating an example of an environment 300, e.g., for monitoring a property. The property can be any appropriate type of property, such as a home, a business, or a combination of both. The environment 300 includes a network 305, a control unit 310, one or more devices 340 and 350, a monitoring system 360, a central alarm system 370, or a combination of two or more of these. In some examples, the network 305 facilitates communications between two or more of the control unit 310, the one or more devices 340 and 350, the monitoring system 360, and the central alarm system 370.

The network 305 is configured to enable exchange of electronic communications between devices connected to the network 305. For example, the network 305 can be configured to enable exchange of electronic communications between the control unit 310, the one or more devices 340 and 350, the monitoring system 360, and the central alarm system 370. The network 305 can include, for example, one or more of the Internet, Wide Area Networks (“WANs”), Local Area Networks (“LANs”), analog or digital wired and wireless telephone networks (e.g., a public switched telephone network (“PSTN”), Integrated Services Digital Network (“ISDN”), a cellular network, and Digital Subscriber Line (“DSL”)), radio, television, cable, satellite, any other delivery or tunneling mechanism for carrying data, or a combination of these. The network 305 can include multiple networks or subnetworks, each of which can include, for example, a wired or wireless data pathway. The network 305 can include a circuit-switched network, a packet-switched data network, or any other network able to carry electronic communications (e.g., data or voice communications). For example, the network 305 can include networks based on the Internet protocol (“IP”), asynchronous transfer mode (“ATM”), the PSTN, packet-switched networks based on IP, X.25, or Frame Relay, or other comparable technologies and can support voice using, for example, voice over IP (“VoIP”), or other comparable protocols used for voice communications. The network 305 can include one or more networks that include wireless data channels and wireless voice channels. The network 305 can be a broadband network.

The control unit 310 includes a controller 312 and a network module 314. The controller 312 is configured to control a control unit monitoring system, e.g., a control unit system, that includes the control unit 310. In some examples, the controller 312 can include one or more processors or other control circuitry configured to execute instructions of a program that controls operation of a control unit system. In these examples, the controller 312 can be configured to receive input from sensors, or other devices included in the control unit system and control operations of devices at the property, e.g., speakers, displays, lights, doors, other appropriate devices, or a combination of these. For example, the controller 312 can be configured to control operation of the network module 314 included in the control unit 310.

The network module 314 is a communication device configured to exchange communications over the network 305. The network module 314 can be a wireless communication module configured to exchange wireless, wired, or a combination of both, communications over the network 305. For example, the network module 314 can be a wireless communication device configured to exchange communications over a wireless data channel and a wireless voice channel. In some examples, the network module 314 can transmit alarm data over a wireless data channel and establish a two-way voice communication session over a wireless voice channel. The wireless communication device can include one or more of a LTE module, a GSM module, a radio modem, a cellular transmission module, or any type of module configured to exchange communications in any appropriate type of wireless or wired format.

The network module 314 can be a wired communication module configured to exchange communications over the network 305 using a wired connection. For instance, the network module 314 can be a modem, a network interface card, or another type of network interface device. The network module 314 can be an Ethernet network card configured to enable the control unit 310 to communicate over a local area network, the Internet, or a combination of both. The network module 314 can be a voice band modem configured to enable the alarm panel to communicate over the telephone lines of Plain Old Telephone Systems (“POTS”).

The control unit system that includes the control unit 310 can include one or more sensors 320. For example, the environment 300 can include multiple sensors 320. The sensors 320 can include a lock sensor, a contact sensor, a motion sensor, a camera (e.g., a camera 330), a flow meter, any other type of sensor included in a control unit system, or a combination of two or more of these. The sensors 320 can include an environmental sensor, such as a temperature sensor, a water sensor, a rain sensor, a wind sensor, a light sensor, a smoke detector, a carbon monoxide detector, or an air quality sensor, to name a few additional examples. The sensors 320 can include a health monitoring sensor, such as a prescription bottle sensor that monitors taking of prescriptions, a blood pressure sensor, a blood sugar sensor, or a bed mat configured to sense presence of liquid (e.g., bodily fluids) on the bed mat. In some examples, the health monitoring sensor can be a wearable sensor that attaches to a person, e.g., a user, at the property. The health monitoring sensor can collect various health data, including pulse, heartrate, respiration rate, sugar or glucose level, bodily temperature, motion data, or a combination of these. The sensors 320 can include a radio-frequency identification (“RFID”) sensor that identifies a particular article that includes a pre-assigned RFID tag.

The control unit 310 can communicate with a module 322 and a camera 330 to perform monitoring. The module 322 is connected to one or more devices that enable property automation, e.g., home or business automation. For instance, the module 322 can connect to, and be configured to control operation of, one or more lighting systems. The module 322 can connect to, and be configured to control operation of, one or more electronic locks, e.g., control Z-Wave locks using wireless communications in the Z-Wave protocol. In some examples, the module 322 can connect to, and be configured to control operation of, one or more appliances. The module 322 can include multiple sub-modules that are each specific to a type of device being controlled in an automated manner. The module 322 can control the one or more devices using commands received from the control unit 310. For instance, the module 322 can receive a command from the control unit 310, which command was sent using data captured by the camera 330 that depicts an area. In response, the module 322 can cause a lighting system to illuminate an area to provide better lighting in the area, and a higher likelihood that the camera 330 can capture a subsequent image of the area that depicts more accurate data of the area.

The camera 330 can be an image camera or other type of optical sensing device configured to capture one or more images. For instance, the camera 330 can be configured to capture images of an area within a property monitored by the control unit 310. The camera 330 can be configured to capture single, static images of the area; video of the area, e.g., a sequence of images; or a combination of both. The camera 330 can be controlled using commands received from the control unit 310 or another device in the property monitoring system, e.g., a device 350.

The camera 330 can be triggered using any appropriate techniques, can capture images continuously, or a combination of both. For instance, a Passive Infra-Red (“PIR”) motion sensor can be built into the camera 330 and used to trigger the camera 330 to capture one or more images when motion is detected. The camera 330 can include a microwave motion sensor built into the camera which is used to trigger the camera 330 to capture one or more images when motion is detected. The camera 330 can have a “normally open” or “normally closed” digital input that can trigger capture of one or more images when external sensors detect motion or other events. The external sensors can include another sensor from the sensors 320, PIR, or door or window sensors, to name a few examples. In some implementations, the camera 330 receives a command to capture an image, e.g., when external devices detect motion or another potential alarm event or in response to a request from a device. The camera 330 can receive the command from the controller 312, directly from one of the sensors 320, or a combination of both.

In some examples, the camera 330 triggers integrated or external illuminators to improve image quality when the scene is dark. Some examples of illuminators can include Infra-Red, Z-wave controlled “white” lights, lights controlled by the module 322, or a combination of these. An integrated or separate light sensor can be used to determine if illumination is desired and can result in increased image quality.

The camera 330 can be programmed with any combination of time schedule, day schedule, system “arming state”, other variables, or a combination of these, to determine whether images should be captured when one or more triggers occur. The camera 330 can enter a low-power mode when not capturing images. In this case, the camera 330 can wake periodically to check for inbound messages from the controller 312 or another device. The camera 330 can be powered by internal, replaceable batteries, e.g., if located remotely from the control unit 310. The camera 330 can employ a small solar cell to recharge the battery when light is available. The camera 330 can be powered by a wired power supply, e.g., the controller's 312 power supply if the camera 330 is co-located with the controller 312.

In some implementations, the camera 330 communicates directly with the monitoring system 360 over the network 305. In these implementations, image data captured by the camera 330 need not pass through the control unit 310. The camera 330 can receive commands related to operation from the monitoring system 360, provide images to the monitoring system 360, or a combination of both.

The environment 300 can include one or more thermostats 334, e.g., to perform dynamic environmental control at the property. The thermostat 334 is configured to monitor temperature of the property, energy consumption of a heating, ventilation, and air conditioning (“HVAC”) system associated with the thermostat 334, or both. In some examples, the thermostat 334 is configured to provide control of environmental (e.g., temperature) settings. In some implementations, the thermostat 334 can additionally or alternatively receive data relating to activity at a property; environmental data at a property, e.g., at various locations indoors or outdoors or both at the property; or a combination of both. The thermostat 334 can measure or estimate energy consumption of the HVAC system associated with the thermostat. The thermostat 334 can estimate energy consumption, for example, using data that indicates usage of one or more components of the HVAC system associated with the thermostat 334. The thermostat 334 can communicate various data, e.g., temperature, energy, or both, with the control unit 310. In some examples, the thermostat 334 can control the environment, e.g., temperature, settings in response to commands received from the control unit 310.

In some implementations, the thermostat 334 is a dynamically programmable thermostat and can be integrated with the control unit 310. For example, the dynamically programmable thermostat 334 can include the control unit 310, e.g., as an internal component to the dynamically programmable thermostat 334. In some examples, the control unit 310 can be a gateway device that communicates with the dynamically programmable thermostat 334. In some implementations, the thermostat 334 is controlled via one or more modules 322.

The environment 300 can include the HVAC system or otherwise be connected to the HVAC system. For instance, the environment 300 can include one or more HVAC modules 337. The HVAC modules 337 can be connected to one or more components of the HVAC system associated with a property. A module 337 can be configured to capture sensor data from, control operation of, or both, corresponding components of the HVAC system. In some implementations, the module 337 is configured to monitor energy consumption of an HVAC system component, for example, by directly measuring the energy consumption of the HVAC system components or by estimating the energy usage of the one or more HVAC system components by detecting usage of components of the HVAC system. The module 337 can communicate energy monitoring information, the state of the HVAC system components, or both, to the thermostat 334. The module 337 can control the one or more components of the HVAC system in response to receipt of commands received from the thermostat 334.

In some examples, the environment 300 includes one or more robotic devices 390. The robotic devices 390 can be any type of robots that are capable of moving, such as an aerial drone, a land-based robot, or a combination of both. The robotic devices 390 can take actions, such as capture sensor data or other actions that assist in security monitoring, property automation, or a combination of both. For example, the robotic devices 390 can include robots capable of moving throughout a property using automated navigation control technology, user input control provided by a user, or a combination of both. The robotic devices 390 can fly, roll, walk, or otherwise move about the property. The robotic devices 390 can include helicopter type devices (e.g., quad copters), rolling helicopter type devices (e.g., roller copter devices that can fly and roll along the ground, walls, or ceiling) and land vehicle type devices (e.g., automated cars that drive around a property). In some examples, the robotic devices 390 can be robotic devices 390 that are intended for other purposes and merely associated with the environment 300 for use in appropriate circumstances. For instance, a robotic vacuum cleaner device can be associated with the environment 300 as one of the robotic devices 390 and can be controlled to take action responsive to monitoring system events.

In some examples, the robotic devices 390 automatically navigate within a property. In these examples, the robotic devices 390 include sensors and control processors that guide movement of the robotic devices 390 within the property. For instance, the robotic devices 390 can navigate within the property using one or more cameras, one or more proximity sensors, one or more gyroscopes, one or more accelerometers, one or more magnetometers, a global positioning system (“GPS”) unit, an altimeter, one or more sonar or laser sensors, any other types of sensors that aid in navigation about a space, or a combination of these. The robotic devices 390 can include control processors that process output from the various sensors and control the robotic devices 390 to move along a path that reaches the desired destination, avoids obstacles, or a combination of both. In this regard, the control processors detect walls or other obstacles in the property and guide movement of the robotic devices 390 in a manner that avoids the walls and other obstacles.

In some implementations, the robotic devices 390 can store data that describes attributes of the property. For instance, the robotic devices 390 can store a floorplan, a three-dimensional model of the property, or a combination of both, that enable the robotic devices 390 to navigate the property. During initial configuration, the robotic devices 390 can receive the data describing attributes of the property, determine a frame of reference to the data (e.g., a property or reference location in the property), and navigate the property using the frame of reference and the data describing attributes of the property. In some examples, initial configuration of the robotic devices 390 can include learning one or more navigation patterns in which a user provides input to control the robotic devices 390 to perform a specific navigation action (e.g., fly to an upstairs bedroom and spin around while capturing video and then return to a property charging base). In this regard, the robotic devices 390 can learn and store the navigation patterns such that the robotic devices 390 can automatically repeat the specific navigation actions upon a later request.

In some examples, the robotic devices 390 can include data capture devices. In these examples, the robotic devices 390 can include, as data capture devices, one or more cameras, one or more motion sensors, one or more microphones, one or more biometric data collection tools, one or more temperature sensors, one or more humidity sensors, one or more air flow sensors, any other type of sensor that can be useful in capturing monitoring data related to the property and users in the property, or a combination of these. The one or more biometric data collection tools can be configured to collect biometric samples of a person in the property with or without contact of the person. For instance, the biometric data collection tools can include a fingerprint scanner, a hair sample collection tool, a skin cell collection tool, or any other tool that allows the robotic devices 390 to take and store a biometric sample that can be used to identify the person (e.g., a biometric sample with DNA that can be used for DNA testing).

In some implementations, the robotic devices 390 can include output devices. In these implementations, the robotic devices 390 can include one or more displays, one or more speakers, any other type of output devices that allow the robotic devices 390 to communicate information, e.g., to a nearby user or another type of person, or a combination of these.

The robotic devices 390 can include a communication module that enables the robotic devices 390 to communicate with the control unit 310, each other, other devices, or a combination of these. The communication module can be a wireless communication module that allows the robotic devices 390 to communicate wirelessly. For instance, the communication module can be a Wi-Fi module that enables the robotic devices 390 to communicate over a local wireless network at the property. Other types of short-range wireless communication protocols, such as 900 MHz wireless communication, Bluetooth, Bluetooth LE, Z-wave, Zigbee, Matter, or any other appropriate type of wireless communication, can be used to allow the robotic devices 390 to communicate with other devices, e.g., in or off the property. In some implementations, the robotic devices 390 can communicate with each other or with other devices of the environment 300 through the network 305.

The robotic devices 390 can include processor and storage capabilities. The robotic devices 390 can include any one or more suitable processing devices that enable the robotic devices 390 to execute instructions, operate applications, perform the actions described throughout this specification, or a combination of these. In some examples, the robotic devices 390 can include solid-state electronic storage that enables the robotic devices 390 to store applications, configuration data, collected sensor data, any other type of information available to the robotic devices 390, or a combination of two or more of these.

The robotic devices 390 can process captured data locally, provide captured data to one or more other devices for processing, e.g., the control unit 310 or the monitoring system 360, or a combination of both. For instance, the robotic device 390 can provide the images to the control unit 310 for processing. In some examples, the robotic device 390 can process the images to determine an identification of the items.

One or more of the robotic devices 390 can be associated with one or more charging stations. The charging stations can be located at a predefined home base or reference location in the property. The robotic devices 390 can be configured to navigate to one of the charging stations after completion of one or more tasks needed to be performed, e.g., for the environment 300. For instance, after completion of a monitoring operation or upon instruction by the control unit 310, a robotic device 390 can be configured to automatically fly to and connect with, e.g., land on, one of the charging stations. In this regard, a robotic device 390 can automatically recharge one or more batteries included in the robotic device 390 so that the robotic device 390 is less likely to need recharging when the environment 300 requires use of the robotic device 390, e.g., absent other concerns for the robotic device 390.

The charging stations can be contact-based charging stations, wireless charging stations, or a combination of both. For contact-based charging stations, the robotic devices 390 can have readily accessible points of contact to which a robotic device 390 can contact on the charging station. For instance, a helicopter type robotic device can have an electronic contact on a portion of its landing gear that rests on and couples with an electronic pad of a charging station when the helicopter type robotic device lands on the charging station. The electronic contact on the robotic device 390 can include a cover that opens to expose the electronic contact when the robotic device is charging and closes to cover and insulate the electronic contact when the robotic device 390 is in operation.

For wireless charging stations, the robotic devices 390 can charge through a wireless exchange of power. In these instances, a robotic device 390 needs only position itself closely enough to a wireless charging station for the wireless exchange of power to occur. In this regard, the positioning needed to land at a predefined home base or reference location in the property can be less precise than with a contact-based charging station. Based on the robotic devices 390 landing at a wireless charging station, the wireless charging station can output a wireless signal that the robotic device 390 receives and converts to a power signal that charges a battery maintained on the robotic device 390. As described in this specification, a robotic device 390 landing or coupling with a charging station can include a robotic device 390 positioning itself within a threshold distance of a wireless charging station such that the robotic device 390 is able to charge its battery.

In some implementations, one or more of the robotic devices 390 has an assigned charging station. In these implementations, the number of robotic devices 390 can equal the number of charging stations. In these implementations, the robotic devices 390 can always navigate to the specific charging station assigned to that robotic device 390. For instance, a first robotic device can always use a first charging station and a second robotic device can always use a second charging station.

In some examples, the robotic devices 390 can share charging stations. For instance, the robotic devices 390 can use one or more community charging stations that are capable of charging multiple robotic devices 390, e.g., substantially concurrently or separately or a combination of both at different times. The community charging station can be configured to charge multiple robotic devices 390 at substantially the same time, e.g., the community charging station can begin charging a first robotic device and then, while charging the first robotic device, begin charging a second robotic device five minutes later. The community charging station can be configured to charge multiple robotic devices 390 in serial such that the multiple robotic devices 390 take turns charging and, when fully charged, return to a predefined home base or reference location or another location in the property that is not associated with a charging station. The number of community charging stations can be less than the number of robotic devices 390.

In some instances, the charging stations might not be assigned to specific robotic devices 390 and can be capable of charging any of the robotic devices 390. In this regard, the robotic devices 390 can use any suitable, unoccupied charging station when not in use, e.g., when not performing an operation for the environment 300. For instance, when one of the robotic devices 390 has completed an operation or is in need of battery charge, the control unit 310 can reference a stored table of the occupancy status of each charging station and instructs the robotic device to navigate to the nearest charging station that has at least one unoccupied charger.

The environment 300 can include one or more integrated security devices 380. The one or more integrated security devices can include any type of device used to provide alerts based on received sensor data. For instance, the one or more control units 310 can provide one or more alerts to the one or more integrated security input/output devices 380. In some examples, the one or more control units 310 can receive sensor data from the sensors 320 and determine whether to provide an alert, or a message to cause presentation of an alert, to the one or more integrated security input/output devices 380.

The sensors 320, the module 322, the camera 330, the thermostat 334, the module 337, the integrated security devices 380, and the robotic devices 390, can communicate with the controller 312 over communication links 324, 326, 328, 332, 336, 338, 384, and 386. The communication links 324, 326, 328, 332, 336, 338, 384, and 386 can be a wired or wireless data pathway configured to transmit signals between any combination of the sensors 320, the module 322, the camera 330, the thermostat 334, the module 337, the integrated security devices 380, the robotic devices 390, or the controller 312. The sensors 320, the module 322, the camera 330, the thermostat 334, the module 337, the integrated security devices 380, and the robotic devices 390, can continuously transmit sensed values to the controller 312, periodically transmit sensed values to the controller 312, or transmit sensed values to the controller 312 in response to a change in a sensed value, a request, or both. In some implementations, the robotic devices 390 can communicate with the monitoring system 360 over network 305. The robotic devices 390 can connect and communicate with the monitoring system 360 using a Wi-Fi or a cellular connection or any other appropriate type of connection.

The communication links 324, 326, 328, 332, 336, 338, 384, and 386 can include any appropriate type of network, such as a local network. The sensors 320, the module 322, the camera 330, the thermostat 334, the robotic devices 390 and the integrated security devices 380, and the controller 312 can exchange data and commands over the network.

The monitoring system 360 can include one or more electronic devices, e.g., one or more computers. The monitoring system 360 is configured to provide monitoring services by exchanging electronic communications with the control unit 310, the one or more devices 340 and 350, the central alarm system 370, or a combination of these, over the network 305. For example, the monitoring system 360 can be configured to monitor events (e.g., alarm events) generated by the control unit 310. In this example, the monitoring system 360 can exchange electronic communications with the network module 314 included in the control unit 310 to receive information regarding events (e.g., alerts) detected by the control unit 310. The monitoring system 360 can receive information regarding events (e.g., alerts) from the one or more devices 340 and 350.

In some implementations, the monitoring system 360 might be configured to provide one or more services other than monitoring services. In these implementations, the monitoring system 360 might perform one or more operations described in this specification without providing any monitoring services, e.g., the monitoring system 360 might not be a monitoring system as described in the example shown in FIG. 3.

In some examples, the monitoring system 360 can route alert data received from the network module 314 or the one or more devices 340 and 350 to the central alarm system 370. For example, the monitoring system 360 can transmit the alert data to the central alarm system 370 over the network 305.

The monitoring system 360 can store sensor and image data received from the environment 300 and perform analysis of sensor and image data received from the environment 300. Based on the analysis, the monitoring system 360 can communicate with and control aspects of the control unit 310 or the one or more devices 340 and 350.

The monitoring system 360 can provide various monitoring services to the environment 300. For example, the monitoring system 360 can analyze the sensor, image, and other data to determine an activity pattern of a person of the property monitored by the environment 300. In some implementations, the monitoring system 360 can analyze the data for alarm conditions or can determine and perform actions at the property by issuing commands to one or more components of the environment 300, possibly through the control unit 310.

The central alarm system 370 is an electronic device, or multiple electronic devices, configured to provide alarm monitoring service by exchanging communications with the control unit 310, the one or more mobile devices 340 and 350, the monitoring system 360, or a combination of these, over the network 305. For example, the central alarm system 370 can be configured to monitor alerting events generated by the control unit 310. In this example, the central alarm system 370 can exchange communications with the network module 314 included in the control unit 310 to receive information regarding alerting events detected by the control unit 310. The central alarm system 370 can receive information regarding alerting events from the one or more mobile devices 340 and 350, the monitoring system 360, or both. In some implementations, the central alarm system 370 can be implemented, at least in part if not entirely, on the monitoring system 360. In these implementations, the monitoring system 360 can perform the operations described with reference to the central alarm system 370.

The central alarm system 370 is connected to multiple terminals 372 and 374. The terminals 372 and 374 can be used by operators to process alerting events. For example, the central alarm system 370, e.g., as part of a first responder system, can route alerting data to the terminals 372 and 374 to enable an operator to process the alerting data. The terminals 372 and 374 can include general-purpose computers (e.g., desktop personal computers, workstations, or laptop computers) that are configured to receive alerting data from a computer in the central alarm system 370 and render a display of information using the alerting data.

For instance, the controller 312 can control the network module 314 to transmit, to the central alarm system 370, alerting data indicating that a sensor 320 detected motion from a motion sensor via the sensors 320. The central alarm system 370 can receive the alerting data and route the alerting data to the terminal 372 for processing by an operator associated with the terminal 372. The terminal 372 can render a display to the operator that includes information associated with the alerting event (e.g., the lock sensor data, the motion sensor data, the contact sensor data, etc.) and the operator can handle the alerting event based on the displayed information. In some implementations, the terminals 372 and 374 can be mobile devices or devices designed for a specific function. Although FIG. 3 illustrates two terminals for brevity, actual implementations can include more (and, perhaps, many more) terminals.

The one or more devices 340 and 350 are devices that can present content, e.g., host and display user interfaces, audio data, or both. For instance, the mobile device 340 is a mobile device that hosts or runs one or more native applications (e.g., the smart property application 342). The mobile device 340 can be a cellular phone or a non-cellular locally networked device with a display. The mobile device 340 can include a cell phone, a smart phone, a tablet PC, a personal digital assistant (“PDA”), or any other portable device configured to communicate over a network and present information. The mobile device 340 can perform functions unrelated to the monitoring system, such as placing personal telephone calls, playing music, playing video, displaying pictures, browsing the Internet, and maintaining an electronic calendar.

The mobile device 340 can include a smart property application 342. The smart property application 342 refers to a software/firmware program running on the corresponding mobile device that enables the user interface and features described throughout. The mobile device 340 can load or install the smart property application 342 using data received over a network or data received from local media. The smart property application 342 enables the mobile device 340 to receive and process image and sensor data from the monitoring system 360.

The device 350 can be a general-purpose computer (e.g., a desktop personal computer, a workstation, or a laptop computer) that is configured to communicate with the monitoring system 360, the control unit 310, or both, over the network 305. The device 350 can be configured to display a smart property user interface 352 that is generated by the device 350 or generated by the monitoring system 360. For example, the device 350 can be configured to display a user interface (e.g., a web page) generated using data provided by the monitoring system 360 that enables a user to perceive images captured by the camera 330, reports related to the monitoring system, or both. Although FIG. 3 illustrates two devices for brevity, actual implementations can include more (and, perhaps, many more) or fewer devices.

In some implementations, the one or more devices 340 and 350 communicate with and receive data from the control unit 310 using the communication link 338. For instance, the one or more devices 340 and 350 can communicate with the control unit 310 using various wireless protocols, or wired protocols such as Ethernet and USB, to connect the one or more devices 340 and 350 to the control unit 310, e.g., local security and automation equipment. The one or more devices 340 and 350 can use a local network, a wide area network, or a combination of both, to communicate with other components in the environment 300. The one or more devices 340 and 350 can connect locally to the sensors and other devices in the environment 300.

Although the one or more devices 340 and 350 are shown as communicating with the control unit 310, the one or more devices 340 and 350 can communicate directly with the sensors and other devices controlled by the control unit 310. In some implementations, the one or more devices 340 and 350 replace the control unit 310 and perform one or more of the functions of the control unit 310 for local monitoring and long range, offsite, or both, communication.

In some implementations, the one or more devices 340 and 350 receive monitoring system data captured by the control unit 310 through the network 305. The one or more devices 340 and 350 can receive the data from the control unit 310 through the network 305, the monitoring system 360 can relay data received from the control unit 310 to the one or more devices 340 and 350 through the network 305, or a combination of both. In this regard, the monitoring system 360 can facilitate communication between the one or more devices 340 and 350 and various other components in the environment 300.

In some implementations, the one or more devices 340 and 350 can be configured to switch whether the one or more devices 340 and 350 communicate with the control unit 310 directly (e.g., through communication link 338) or through the monitoring system 360 (e.g., through network 305) based on a location of the one or more devices 340 and 350. For instance, when the one or more devices 340 and 350 are located close to, e.g., within a threshold distance of, the control unit 310 and in range to communicate directly with the control unit 310, the one or more devices 340 and 350 use direct communication. When the one or more devices 340 and 350 are located far from, e.g., outside the threshold distance of, the control unit 310 and not in range to communicate directly with the control unit 310, the one or more devices 340 and 350 use communication through the monitoring system 360.

Although the one or more devices 340 and 350 are shown as being connected to the network 305, in some implementations, the one or more devices 340 and 350 are not connected to the network 305. In these implementations, the one or more devices 340 and 350 communicate directly with one or more of the monitoring system components and no network (e.g., Internet) connection or reliance on remote servers is needed.

In some implementations, the one or more devices 340 and 350 are used in conjunction with only local sensors and/or local devices in a house. In these implementations, the environment 300 includes the one or more devices 340 and 350, the sensors 320, the module 322, the camera 330, and the robotic devices 390. The one or more devices 340 and 350 receive data directly from the sensors 320, the module 322, the camera 330, the robotic devices 390, or a combination of these, and send data directly to the sensors 320, the module 322, the camera 330, the robotic devices 390, or a combination of these. The one or more devices 340 and 350 can provide the appropriate interface, processing, or both, to provide visual surveillance and reporting using data received from the various other components.

In some implementations, the environment 300 includes network 305 and the sensors 320, the module 322, the camera 330, the thermostat 334, and the robotic devices 390 are configured to communicate sensor and image data to the one or more devices 340 and 350 over network 305. In some implementations, the sensors 320, the module 322, the camera 330, the thermostat 334, and the robotic devices 390 are programmed, e.g., intelligent enough, to change the communication pathway from a direct local pathway when the one or more devices 340 and 350 are in close physical proximity to the sensors 320, the module 322, the camera 330, the thermostat 334, the robotic devices 390, or a combination of these, to a pathway over network 305 when the one or more devices 340 and 350 are farther from the sensors 320, the module 322, the camera 330, the thermostat 334, the robotic devices 390, or a combination of these.

In some examples, the monitoring system 360 leverages GPS information from the one or more devices 340 and 350 to determine whether the one or more devices 340 and 350 are close enough to the sensors 320, the module 322, the camera 330, the thermostat 334, the robotic devices 390, or a combination of these, to use the direct local pathway or whether the one or more devices 340 and 350 are far enough from the sensors 320, the module 322, the camera 330, the thermostat 334, the robotic devices 390, or a combination of these, that the pathway over network 305 is required. In some examples, the monitoring system 360 leverages status communications (e.g., pinging) between the one or more devices 340 and 350 and the sensors 320, the module 322, the camera 330, the thermostat 334, the robotic devices 390, or a combination of these, to determine whether communication using the direct local pathway is possible. If communication using the direct local pathway is possible, the one or more devices 340 and 350 communicate with the sensors 320, the module 322, the camera 330, the thermostat 334, the robotic devices 390, or a combination of these, using the direct local pathway. If communication using the direct local pathway is not possible, the one or more devices 340 and 350 communicate with the sensors 320, the module 322, the camera 330, the thermostat 334, the robotic devices 390, or a combination of these, using the pathway over network 305.

In some implementations, the environment 300 provides people with access to images captured by the camera 330 to aid in decision-making. The environment 300 can transmit the images captured by the camera 330 over a network, e.g., a wireless WAN, to the devices 340 and 350. Because transmission over a network can be relatively expensive, the environment 300 can use several techniques to reduce costs while providing access to significant levels of useful visual information (e.g., compressing data, down-sampling data, sending data only over inexpensive LAN connections, or other techniques).

In some implementations, a state of the environment 300, one or more components in the environment 300, and other events sensed by a component in the environment 300 can be used to enable/disable video/image recording devices (e.g., the camera 330). In these implementations, the camera 330 can be set to capture images on a periodic basis when the alarm system is armed in an “away” state, set not to capture images when the alarm system is armed in a “stay” state or disarmed, or a combination of both. In some examples, the camera 330 can be triggered to begin capturing images when the control unit 310 detects an event, such as an alarm event, a door-opening event for a door that leads to an area within a field of view of the camera 330, or motion in the area within the field of view of the camera 330. In some implementations, the camera 330 can capture images continuously, but the captured images can be stored or transmitted over a network when needed.

Although FIG. 3 depicts the monitoring system 360 as remote from the control unit 310, in some examples the control unit 310 can be a component of the monitoring system 360. For instance, both the monitoring system 360 and the control unit 310 can be physically located at a property that includes the sensors 320 or at a location outside the property.

In some examples, some of the sensors 320, the robotic devices 390, or a combination of both, might not be directly associated with the property. For instance, a sensor or a robotic device might be located at an adjacent property or on a vehicle that passes by the property. A system at the adjacent property or for the vehicle, e.g., that is in communication with the vehicle or the robotic device, can provide data from that sensor or robotic device to the control unit 310, the monitoring system 360, or a combination of both.

A number of implementations have been described. Nevertheless, it will be understood that various modifications can be made without departing from the spirit and scope of the disclosure. For example, various forms of the flows shown above can be used, with operations re-ordered, added, or removed.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory program carrier for execution by, or to control the operation of, a data processing apparatus. Alternatively or in addition, the program instructions can be encoded on an artificially-generated propagated signal, e.g., a machine-generated electrical, optical, or electromagnetic signal, that is generated to encode information for transmission to a suitable receiver apparatus for execution by a data processing apparatus. One or more computer storage media can include a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can be or include special purpose logic circuitry, e.g., a field programmable gate array (“FPGA”) or an application-specific integrated circuit (“ASIC”). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can be performed by, and apparatus can also be implemented as, special purpose logic circuitry, e.g., a field programmable gate array (“FPGA”) or an application-specific integrated circuit (“ASIC”).

Computers suitable for the execution of a computer program include, by way of example, general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. A computer can be embedded in another device, e.g., a mobile telephone, a smart phone, a headset, a personal digital assistant (“PDA”), a mobile audio or video player, a game console, a Global Positioning System (“GPS”) receiver, or a portable storage device, e.g., a universal serial bus (“USB”) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a liquid crystal display (“LCD”), an organic light emitting diode (“OLED”) or other monitor, for displaying information to the user and a keyboard and a pointing device, e.g., a mouse or a trackball or a touchscreen, by which the user can provide input to the computer. Other kinds of devices can be used to provide for interaction with a user as well. For example, feedback provided to the user can be any form of sensory feedback, e.g., visual feedback, auditory feedback, or tactile feedback; and input from the user can be received in any form, including acoustic, speech, or tactile input. In some examples, a computer can interact with a user by sending documents to and receiving documents from a device that is used by the user; for example, by sending web pages to a web browser on a user's device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, e.g., an Hypertext Markup Language (“HTML”) page, to a user device, e.g., for purposes of displaying data to and receiving user input from a user device, which acts as a client. Data generated at the user device, e.g., a result of user interaction with the user device, can be received from the user device at the server.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some instances be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the invention have been described. Other implementations are within the scope of the following claims. For example, the operations recited in the claims, described in the specification, or depicted in the figures can be performed in a different order and still achieve desirable results. In some implementations, multitasking and parallel processing may be advantageous.

1. A computer-implemented method comprising:
providing, to an artificial intelligence model and for an event at a property, contextual information that includes a) first data representing sensor data for the event, b) a role of a person for whom notification instructions are sent, c) an event type for the event, and d) activity data that indicates an activity in which the person is likely involved;
in response to providing the contextual information, receiving, from the artificial intelligence model, output that indicates an action for the event; and
sending, to a device, instructions to cause the device to perform the action.

2. The method of claim 1, comprising:
determining the person for whom notification instructions are sent; and
accessing historical notification data for the person, wherein:
providing the contextual data comprises providing, to the artificial intelligence model and for the event at the property, the contextual information that includes a) the first data representing the sensor data for the event, b) the role of the person for whom notification instructions are sent, c) the event type for the event, d) the activity data that indicates an activity in which the person is likely involved, and e) the historical notification data for the person.

3. The method of claim 2, comprising:
selecting, from a plurality of people and using the first data representing the sensor data for the event or the event type for the event, the person.

4. The method of claim 1, comprising:
determining the person for whom notification instructions are sent; and
accessing recent historical notification data that is i) for the person, and ii) that indicates notifications presented, during a time period that satisfies a time period threshold for the event, by one or more of devices for an account associated with the person, or presented by devices for the person, wherein:
providing the contextual data comprises providing, to the artificial intelligence model and for the event at the property, the contextual information that includes a) the first data representing the sensor data for the event, b) the role of the person for whom notification instructions are sent, c) the event type for the event, d) the activity data that indicates an activity in which the person is likely involved, and e) the recent historical notification data for the person.

5. The method of claim 1, comprising:
receiving a request prior to providing the contextual information to the artificial intelligence model, wherein:
providing the contextual information comprises providing, to the artificial intelligence model, the contextual information that includes second data for the request.

6. The method of claim 1, wherein receiving the output comprises receiving the output that indicates a notification regarding the event for presentation.

7. The method of claim 6, comprising:
determining, using at least a portion of the output, a presentation type for the notification; and
generating the notification using the presentation type.

8. The method of claim 7, wherein the presentation type comprises at least one of a visual notification or an audible notification.

9. The method of claim 6, comprising:
selecting, from two or more notification types and using at least a portion of the output, a notification type; and
generating the notification using the notification type.

10. The method of claim 9, wherein the notification type comprises a response that satisfies a response criterion, a suggestion that does not satisfy the response criterion and satisfies a suggestion criterion, or a request for additional information.

11. The method of claim 1, wherein the first data representing the sensor data for the event comprises the sensor data.

12. The method of claim 11, comprising:
determining that values for one or more predetermined attributes of the sensor data are not stored in memory,
wherein providing the contextual information to the artificial intelligence model comprises providing the contextual information for the event at the property that includes the sensor data in response to determining that values for the one or more predetermined attributes of the sensor data are not stored in memory.

13. The method of claim 1, wherein the first data representing the sensor data for the event comprises a vector that represents values for one or more predetermined attributes of the sensor data.

14. The method of claim 1, comprising:
generating, using sensor data from one or more devices for the property, a textual representation of at least a portion of the event; and
storing, as at least some of the first data representing the sensor data for the event, the textual representation of at least the portion of the event.

15. The method of claim 1, wherein the contextual information comprises a location for the event.

16. The method of claim 1, wherein the contextual information comprises one or more of historical data for the property, second data that indicates whether the event is expected, an event trigger type, or a state of a monitoring system at the property.

17. The method of claim 1, wherein the role for the person comprises at least one of an emergency responder, a visitor at the property, a manager for the property, or a security person for the property.

18. The method of claim 1, comprising:
determining an event type of the event at the property; and
determining whether the event type satisfies an event type criterion that identifies an event for which a default action should always be performed,
wherein providing the contextual information to the artificial intelligence model is responsive to determining that the event type does not satisfy the event type criterion and that the default action should not always be performed for the event.

19. One or more computer storage media encoded with instructions that, when executed by one or more computers, cause the one or more computers to perform operations comprising:
providing, to an artificial intelligence model and for an event at a property, contextual information that includes a) first data representing sensor data for the event, b) a role of a person for whom notification instructions are sent, c) an event type for the event, and d) activity data that indicates an activity in which the person is likely involved;
in response to providing the contextual information, receiving, from the artificial intelligence model, output that indicates an action for the event; and
sending, to a device, instructions to cause the device to perform the action.

20. A system comprising one or more computers and one or more storage devices on which are stored instructions that are operable, when executed by the one or more computers, to cause the one or more computers to perform operations comprising:
providing, to an artificial intelligence model and for an event at a property, contextual information that includes a) first data representing sensor data for the event, b) a role of a person for whom notification instructions are sent, c) an event type for the event, and d) activity data that indicates an activity in which the person is likely involved;
in response to providing the contextual information, receiving, from the artificial intelligence model, output that indicates an action for the event; and
sending, to a device, instructions to cause the device to perform the action.
